(19) United States
(12) Patent Application Publication
(10) Pub. No.: US 2011/0055697 A1
(43) Pub. Date: Mar. 3, 2011

(54) ALPHANUMERIC KEYPAD FOR TOUCH-SCREEN DEVICES

(76) Inventors: Wayne Davidson, Leesburg, VA (US); Beth Davidson, Leesburg, VA (US)

(21) Appl. No.: 12/791,542

(22) Filed: Jun. 1, 2010

Related U.S. Application Data
(60) Provisional application No. 61/237,182, filed on Aug. 26, 2009.

(51) Int. Cl. G06F 3/01; G06F 3/033; G06F 3/048

(52) U.S. Cl. 715/702; 715/863; 715/773

(57) ABSTRACT

A method and apparatus for improving the accuracy and usability of alphanumeric keypads and control functions on touch-screen devices by employing multi-function buttons and the actuation of multiple buttons in sequence by sliding a finger across the touch-screen. Potential applications include cell phones, smart phones, calculators, handheld scanners, gaming systems, remote controls, GPS navigation devices, and ultra small laptop computers. A first embodiment is an alphanumeric keypad for a touch-screen smart phone. In this embodiment, a modified QWERTY keypad layout is employed to allow selection of the most frequently used letters by touching the display and the selection of less frequently used letters by sliding a finger on the display. In this first embodiment, multiple letters can be entered in sequence by sliding from one button to either an adjacent or non-adjacent button. A second embodiment is a numeric keypad for entering phone numbers on a touch-screen phone.

### CROSS-REFERENCE TO RELATED APPLICATIONS/INCORPORATION BY REFERENCE

This application claims priority to U.S. Application Ser. No. 61/237,182 filed Aug. 26, 2010, which is incorporated by reference herein in its entirety.

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

The present invention relates generally to touch-screen electronic devices and systems, such as cell phones, smart phones, calculators, handheld scanners, gaming systems, remote controls, GPS navigation devices, and ultra small laptop computers. More particularly, the invention relates to a touch-screen keypad for data entry into such systems.

### BACKGROUND OF THE INVENTION

As touch-screen electronic devices continue to be reduced in size, device manufacturers are increasingly challenged with designing alphanumeric keypads that are small yet accurate and easy to use. Typically these devices display 26 distinct buttons (one for each letter in the alphabet) in an area that is about 1200 sq. mm—thus, the surface area allocated to each button is less than 50 sq. mm. The buttons are typically arranged in rows and/or columns with minimal spacing between adjacent buttons.

Given the large number of small, closely spaced buttons, accurate entry of alphanumeric characters can be difficult—particularly for those with large hands or those who have difficulty reading small type.

Furthermore, since touch-screens do not provide tactile feedback, it is very difficult to input text without visually verifying whether each letter has been correctly selected. Similarly, it is difficult to accurately enter a phone number on a numeric keypad without visual verification—even though the keys are typically much larger.

It is therefore, an object of the present invention to improve the accuracy and ease of entering alphanumeric characters into touch-screen devices both with and without visual verification.

### BRIEF SUMMARY OF THE INVENTION

The object of the invention is achieved via two design methods:

1. The use of a multi-function button that allows entry of multiple distinct characters. This multi-function button visually presents a primary key and one or more additional keys formed in subtending portions. Each button represents two or more alphanumeric characters.

2. The deterministic actuation of multiple distinct buttons in sequence as the user slides a finger across multiple buttons. More specifically, an actuated button can be either adjacent or non-adjacent to the previously actuated button.

One embodiment of the present invention is an alphanumeric keypad for a touch-screen smart phone such as an Apple iPhone phone. A second embodiment of the invention is a numeric keypad for dialing phone numbers on a touch-screen phone.

The first embodiment—an alphanumeric keypad—comprises a modification to the QWERTY keypad layout that organizes letters according to the frequency of letter usage. More specifically, letters are placed to allow selection of the most frequently used letters just by touching the touch-screen display and selection of less frequently used letters by sliding a finger to a subtending portion of a key.

In this embodiment, a specialized software algorithm will be used to accurately detect entry of each alphanumeric character that is displayed. It is envisioned that typical applications for this embodiment would be smart phone devices such as the iPhone phone or Blackberry Storm device and portable navigation devices such as a Garmin device.

In this embodiment, a touch sensitive display screen would consist of both single-function buttons and multi-function buttons. Each multi-function button visually indicates a primary key, which is selected by touching, and a second key formed as a subtending portion, which is selected by sliding down to the subtending portions.

This keypad comprises sixteen (16) single-function buttons and six (6) multi-function buttons to enter one of 28 characters (26 letters plus two punctuation marks).

This keypad consists of only six (6) buttons per row versus typical touch-screen keypads, which have nine (9) to ten (10) buttons on each row. Thus, the buttons in this embodiment are much wider than typical touch-screen keypads.

The second embodiment—a numeric keypad—comprises twelve (12) single function buttons (the numbers 0 to 9, *, and #) arranged in 4 rows as is typically done on current numeric touch-screen keypads. The present invention differs from current designs, since multiple numbers can be entered in sequence by sliding from one key to adjacent or non-adjacent keys.

### BENEFITS OF THE INVENTION

The key benefits of the present invention are:
a. The width of each button is much greater.
b. The alphanumeric labels on the buttons are more readable.
c. The user can select and enter characters more accurately, especially with one hand.
d. The user can enter numbers or letters with less visual verification.

### BRIEF DESCRIPTION OF THE DRAWINGS

FIG. 1 shows the primary display of a keypad embodiment of the present invention having a modified QWERTY layout on a touch-screen device such as the Apple iPhone phone.

FIG. 2 shows a secondary display of the keypad embodiment for entry of numeric and special characters.

FIG. 3 shows a comparison of the keypad of FIG. 1 and a traditional QWERTY keypad layout on a touch-screen device such as the Apple iPhone phone.

FIG. 4 shows user actuation for selection of the letter (F) and the letter (I)—which are frequently used letters—on the keypad of FIG. 1.

FIG. 5 shows user actuation for selection of a letter (X)—which is an infrequently used letter—on the keypad of FIG. 1.

FIG. 6 shows user actuation of the letters (U) and (P) sequentially by sliding a finger between adjacent buttons on the keypad of FIG. 1.

FIG. 7 shows user actuation of the letters (T) and (0) sequentially by sliding a finger between non-adjacent buttons on the keypad of FIG. 1.

FIG. 8 shows user actuation of the letters (H), (I), and (T) sequentially by sliding to a second button—then changing the sliding direction to a third button on the keypad of FIG. 1.

FIG. 9 shows user actuation of the letters (P), (I), and (N) sequentially by sliding diagonally between multiple buttons.

FIG. 10 shows user actuation of numbers and characters on the secondary display of FIG. 2.

FIG. 11 shows user actuation of the numbers (2), (8), and (9) sequentially by sliding between multiple buttons on a numeric keypad that is used to dial phone numbers.

### DETAILED DESCRIPTION OF THE PREFERRED EMBODIMENT

Referring to Table 1, an important aspect of the design is the incorporation into the design of the frequency of letter usage in the English language. In this embodiment, the primary letters are used of 99% of the time—and thus can be selected more easily and rapidly with a typical touch contact with the screen. The second letters require an additional sliding movement—but since they are rarely selected—do not impact the speed of entering text. Also referring to Table 1, the top and bottom rows—Row 1 and Row 2 contain less frequently used letters, which facilitates the entry of multiple sequential letters.

TABLE 2

| | |
|---|---|
| Touch | Slide |

| | | | |
|---|---|---|---|
| W | 1.9% | | |
| Y | 1.7% | | |
| U | 2.7% | | |
| P | 2.0% | | |
| Row 1 | 8.4% | | |
| E | 12.5% | | |
| R | 6.1% | | |
| T | 9.3% | | |
| I | 7.3% | | |
| O | 7.6% | | |
| L | 4.1% | | |
| Row 2 | 46.9% | | |
| A | 8.0% | | |
| S | 6.5% | | |
| D | 4.0% | | |
| H | 5.5% | | |
| N | 7.1% | | |
| M | 2.5% | | |
| Row 3 | 33.7% | | |
| C | 3.1% | Q | 0.1% |
| F | 2.3% | Z | 0.1% |
| G | 2.0% | X | 0.2% |
| V | 1.0% | J | 0.2% |
| B | 1.5% | | |
| K | 0.7% | | |
| Row 4 | 10.5% | | 0.6% |
| Total | 99.4% | | 0.6% |

TABLE 1

Letter Frequency in the English Language
e t a o i n s r h l d c u m f p g w y b v k x j q z
Letter Frequency of the Most Common 1st Letter in Words
t o a w b c d s f m r h i y e g l n p u j k
Letter Frequency of the Most Common 2nd Letter in Words
h o e i a u n r t
Letter Frequency of the Most Common 3rd Letter in Words
e s a r n i
Letter Frequency of the Most Common Last Letter in Words
e s t d n r y f l o g h a k m p u w
More than half of all words end with: e t d s
e s t d n r y o f g a l h m u k i w p c x b z v j q
Digraph Frequency
th he an in er on re ed nd ha at en es of nt ea ti to io le is ou
ar as de rt ve
Trigraph Frequency
the and tha ent ion tio for nde has nce tis oft men
Word Frequency for the Most Common Words
the of and to in a is that be it by are for was as he with on his
at which but from has this will one have not were or all their
an i there been many more so when had may today who would
time we about after dollars if my other some them being its no
only over very you into most than they day even made out first
great must these can days every found general her here last
new now people public said since still such through under up
war well where while years before between country debts
good him interest large like make our take upon what

Referring to Table 2, the example embodiment also relies on other letter usage statistics (e.g., common words, diagraphs frequency, etc.) to optimally arrange letters for maximum speed and accuracy of text entry.

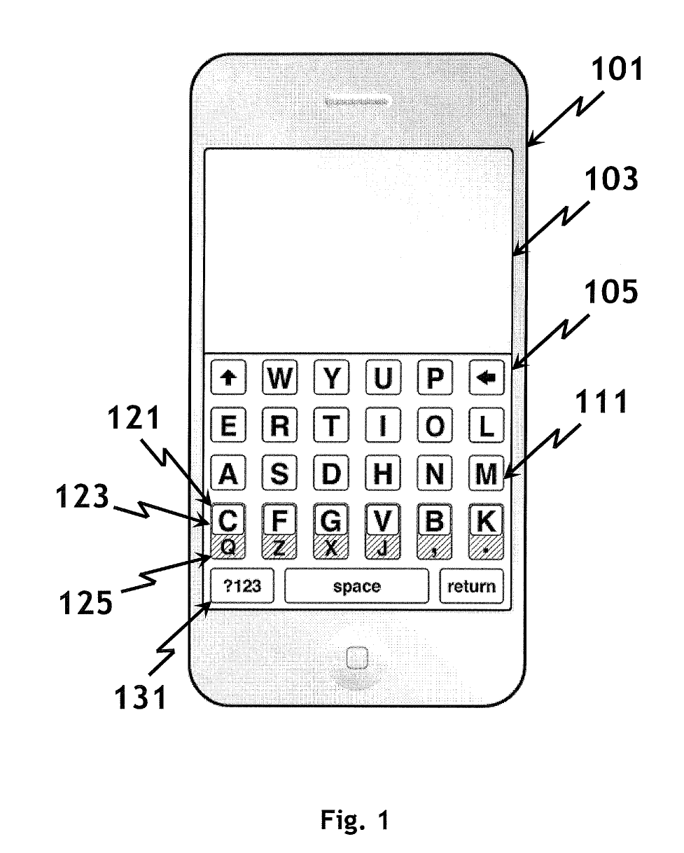

Referring to FIG. 1, a touch screen phone 101 includes a touch screen display 103 having a touch-operated keypad 105. Keypad 105 graphically displays sixteen (16) single-function buttons 111 and six (6) multi-function buttons 121 that are used to enter one of twenty-eight (28) alphanumeric characters (twenty-six letters plus two punctuation marks) into device 101. Each single-function button 111 and each multi-function button 121 is a discrete rectangular area of the touch display 103.

Button 121 has a primary key 123 and a secondary key 125. Primary key 123 is located as the upper portion of the rectangular area of button 121, for example, the top one-half of the rectangular area, and visually presents a primary alphabet character to be entered by dual-function button 121. Secondary key 125 is located as the lower portion of the rectangular area of button 121, for example, the bottom one-half of the rectangular area, and visually presents a secondary alphabet character to be entered by dual-function button 121.

A primary key 123 is actuated by touching anywhere on the entire button 121 and then releasing contact. The secondary key 125 is actuated by touching anywhere on button 121, and then sliding downward, and then releasing contact.

The specialized software algorithm that is used to determine the selected letter for a button 121 is as follows:

1. If the starting touch-point and ending touch-point are equal (within a defined margin of error), the actuation is defined as a “touch” motion and one of the six primary letters are selected (i.e., C, F, G, V, B, or K).

2. If the starting touch-point and ending touch-point are different (greater than the margin of error), the distance travelled horizontally (x-axis) and vertically (y-axis) is computed.

3. If the ending point is vertically below the starting point, the secondary character in the lower subtending portion of the button 121 is selected (i.e., Q, Z, X, J, comma, or period).

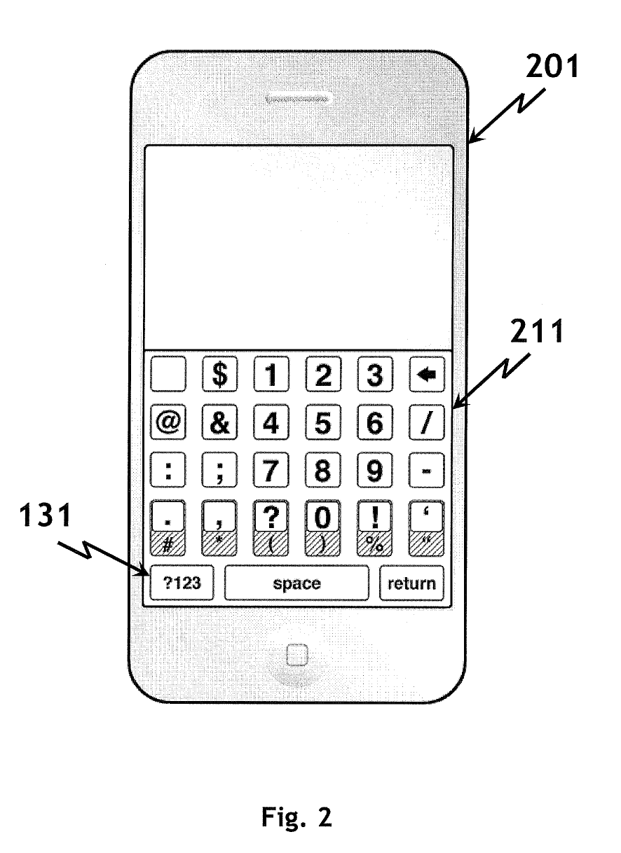

Referring to FIG. 2, a secondary display of the keypad for entering numbers and special characters is shown. A user can alternate between the primary display in FIG. 1 and the secondary display of FIG. 2 by actuating button 131, which is on both the primary and secondary displays.

The present invention has been implemented as an iPhone Application using Xcode Version 3.2.2 and iPhone Software Development Kit (SDK) Version 3.1.3 Printed Copies of the four C-Code files that were written for said iPhone Application implementation are filed herewith as Exhibits A, B, C, and D incorporated herein by reference. As will suggest itself, other software may be used to implement the present invention on other specific phones and types of devices.

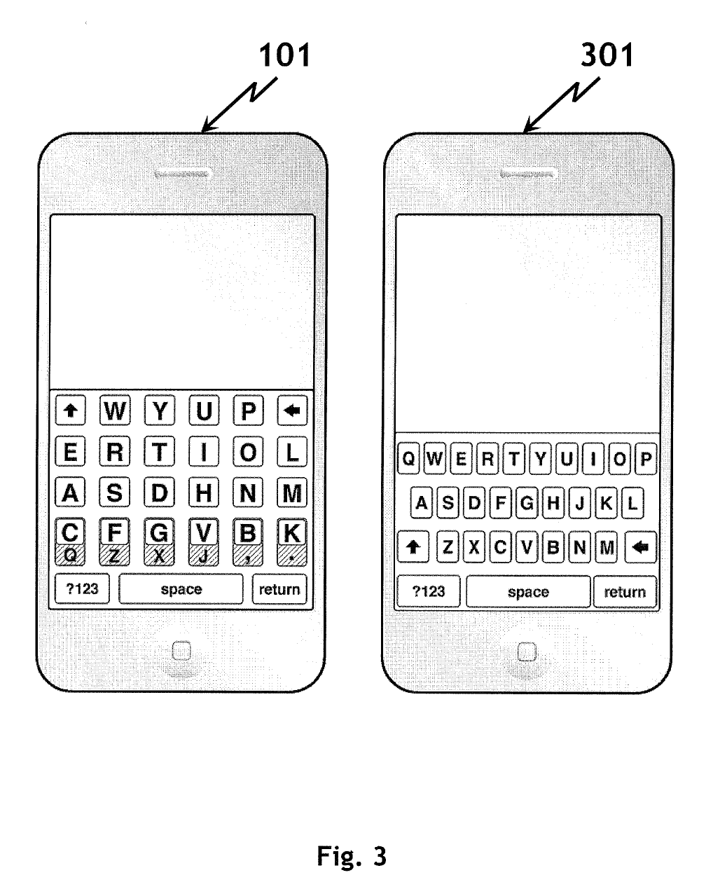

FIG. 3 shows a comparison of an embodiment of the present invention at 101 with the current state of the art that is available on the iPhone at 301.

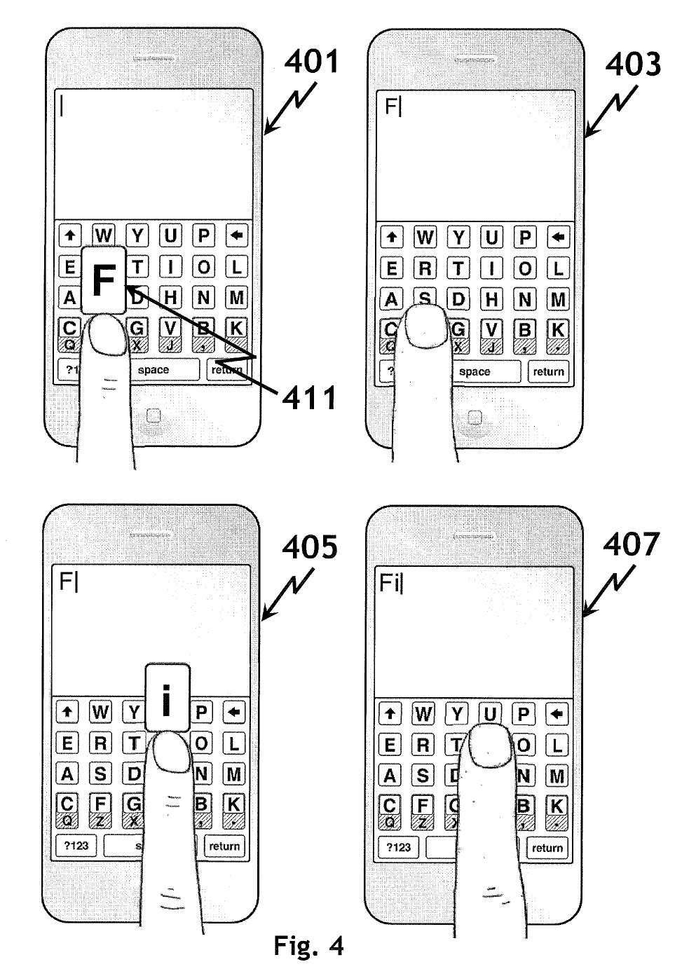

Referring to FIG. 4, screenshots 401, 403 show the selection of a primary letter “F” using a multi-function button 121 (FIG. 1). In screenshot 401, the button 121 is touched (contacted) and a “pop-up” display 411 of the letter “F” appears above the touched button on the display 103, as shown. In screen shot 403, the touch contact is removed and pop-up 411 is removed and the letter “F” is added to the display as text in the display area above keypad 105. Similarly in screenshots 405 and 407, selection of the letter “I” on a single-function button 111 (FIG. 1) is shown.

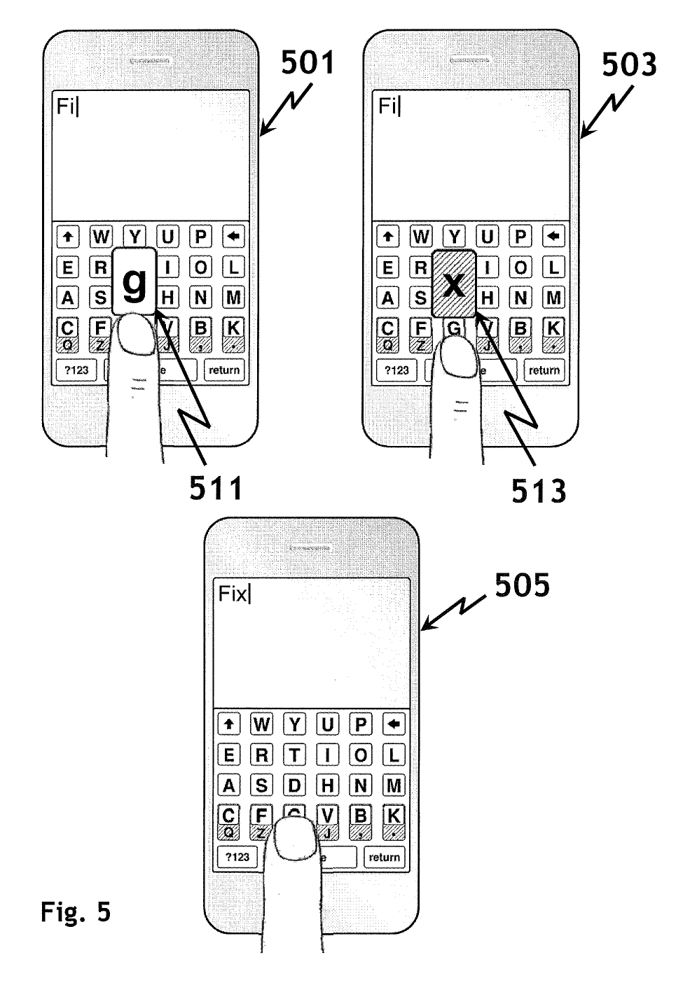

Referring to FIG. 5, screenshots 501, 503 and 505 show the selection of a lower letter on a multi-function button 121 (FIG. 1). In screenshot 501, a multi-function button 121 is touched so that a “pop-up” display 511 with the letter “g” occurs above the touched button on the display 103, as shown. In screenshot 503, the user maintains contact with button 121 and with a sliding motion moves a finger down to the lower portion, i.e., the secondary key 125, of button 121. The pop-up 511 is removed and a new popup display 513 with the letter “X” appears on the screen above the touched button. In screenshot 505, the touch contact is removed, pop-up display 513 is removed and the letter “Y” is added to the display as text in the display area above keypad 105. As shown in screen shots 501, 503, the first pop-up 511 and the second pop-up 513 are highlighted with a different color, e.g., pop-up 511 is white and pop-up 513 is red, to provide confirmation to the user that the secondary character will be entered.

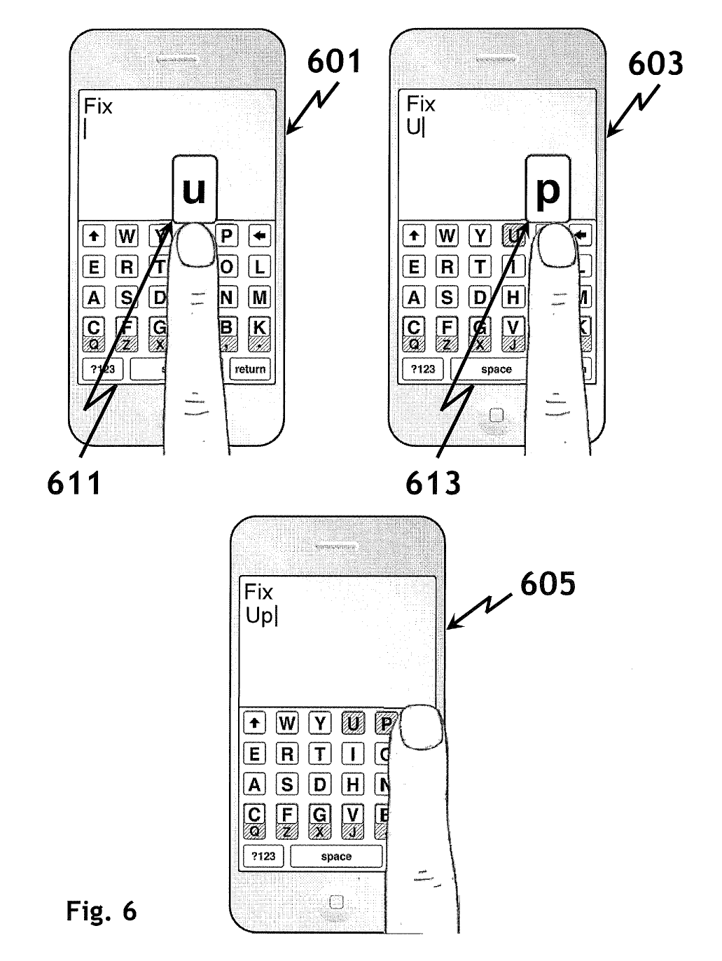

Referring to FIG. 6, screenshots 601, 603, and 605 show sequential entry of multiple letters by sliding from a first button 111 to a second adjacent button 111. In screenshot 601, a single-function button 111 is touched (contacted) and a “pop-up” display 611 with the letter “U” appears on the screen. In screenshot 603, the user maintains contact with the “U” button 111 and then with a sliding motion moves a finger laterally to the adjacent button, the “P” button 111. In response to this sliding action between two buttons 111, the pop-up display 611 is removed; the letter “U” is added as text; and a new pop-up display 613 with the letter “P” appears on the screen. In screenshot 605, the touch contact is removed from the “P” button, the pop-up display is removed and the letter “P” is added to the display as text. As shown in screenshots 603 and 605, the first button 111 contacted and the adjacent button 111 are highlighted with a color (e.g., green) different than the original color of the buttons (e.g., white) during a multi-button sequence to provide confirmation to the user that multiple letters will be entered.

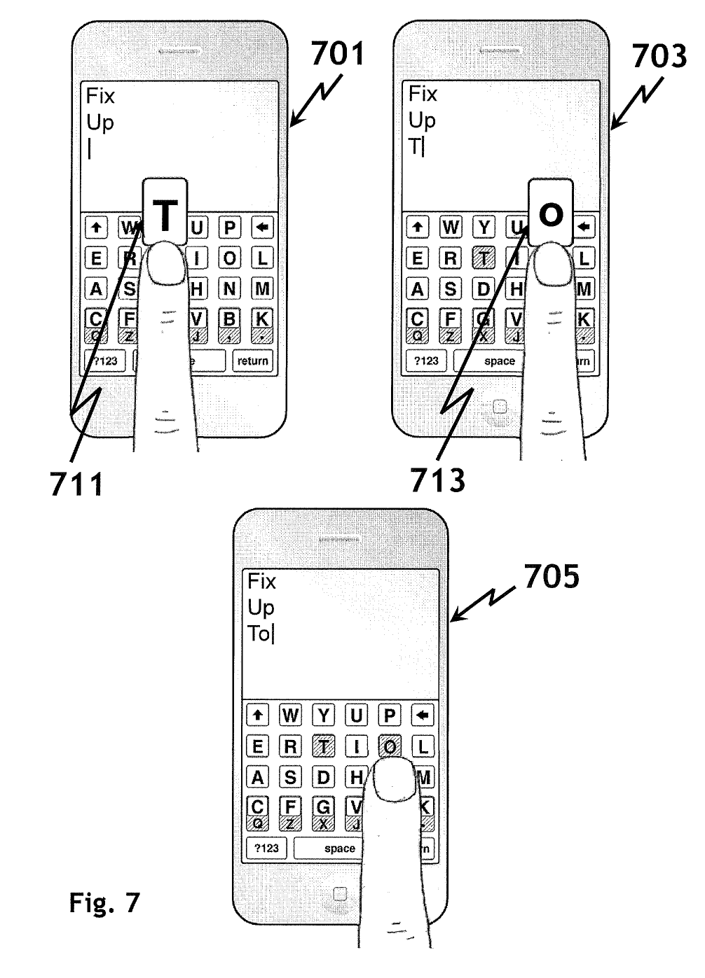

Referring to FIG. 7, screenshots 701, 703, and 705 show sequential entry of multiple letters by sliding from a first button to a second non-adjacent button. In screenshot 701, a single-function button 111 is touched (contacted) and a “pop-up” display 711 with the letter “T” appears on the screen. In screenshot 703, the user maintains contact with button 111 and then with a sliding motion moves a finger laterally across the adjacent button and to a non-adjacent button 111, where the finger stops but remains in contact with the non-adjacent button 111. The pop-up display 711 is removed; the letter “T” is added as text; and a new popup display with the letter “O” appears on the screen. In screenshot 705, the touch contact is removed from the “O” button, the pop-up display 713 is removed and the letter “O” is added to the display as text. The buttons (“T” and “O”) remain green highlighted momentarily, e.g., 300 milliseconds, and then the green highlighting is removed. This provides visual feedback to the user that those letters were successfully entered. An important aspect of this invention is the determination of whether to actuate an intermediate button—in this case button 111 with the letter “I”—since it is contacted as the finger moves to the non-adjacent button. A number of different selection criteria can be implemented by those skilled in the art to accurately detect non-selection of intermediate buttons. In this embodiment, two methods are implemented concurrently to determine if intermediate buttons should be activated:

1. The instantaneous speed of the finger is continuously monitored and if the speed at the time of contact of the intermediate button drops below a pre-determined threshold—the intermediate button is activated.

2. The instantaneous direction of the finger movement is continuously monitored (i.e., via well known mathematical formulas applied to the change in X & Y coordinates). If a differential direction is above a pre-determined threshold at the time of contact of the intermediate button,—the intermediate button is selected. In this embodiment, direction is measured in degrees between 0 and 360 degrees with a threshold of 25 degrees.

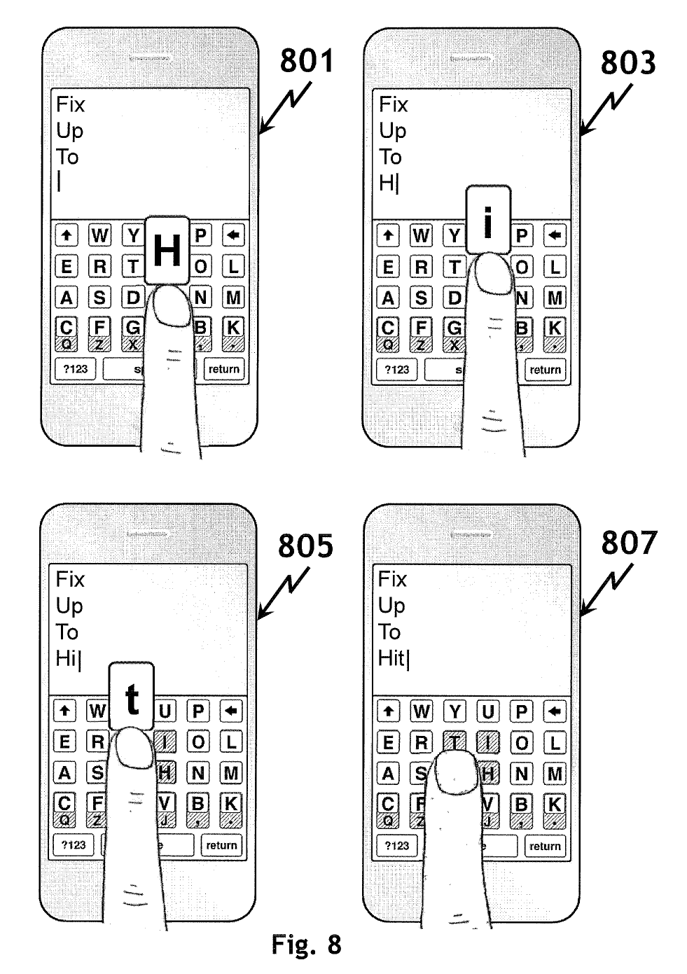

Referring to FIG. 8, screenshots 801, 803, and 805 show actuation of three buttons in sequence in which a change in direction is detected. As seen from screenshots 801 and 803, the initial direction of the finger movement is 360 degrees (vertically up), beginning at the button for the letter “H” and moving to the button for the letter “I”. In screenshot 805, the direction of movement changes to 270 degrees (horizontally to the left) moving from the button for the letter I to the button for the letter “T”. Since the direction change is 90 degrees, which is greater than the 25 degrees, the intermediate button for the letter “I” is actuated. If the movement would have continued vertically up to the button for the letter “U”, the letter “I” would not have been entered.

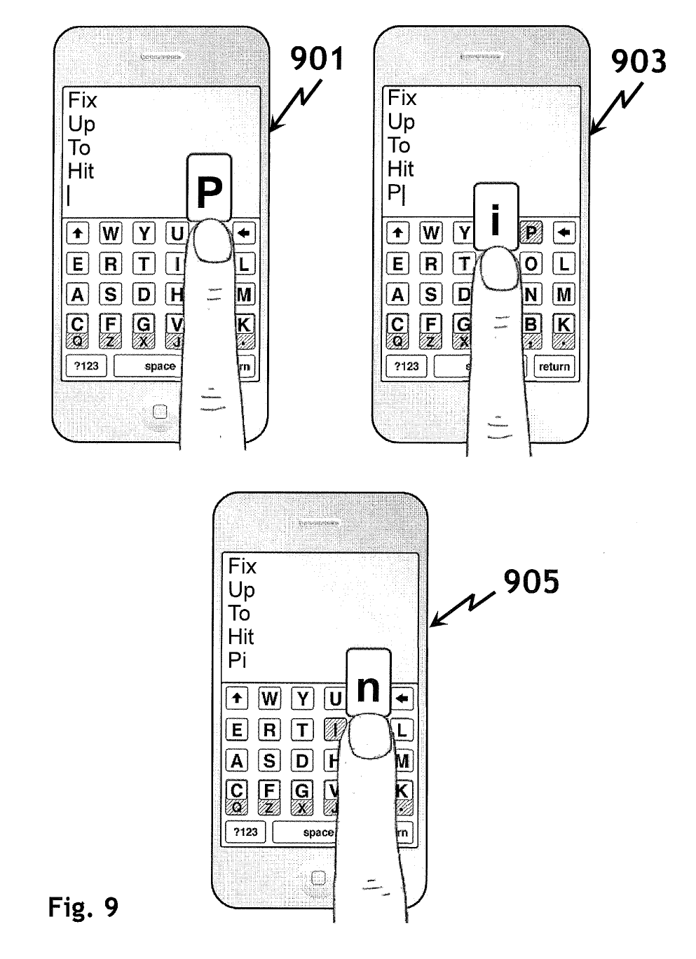

Similarly in FIG. 9, the same principle of direction change can be applied to diagonally adjacent buttons as well.

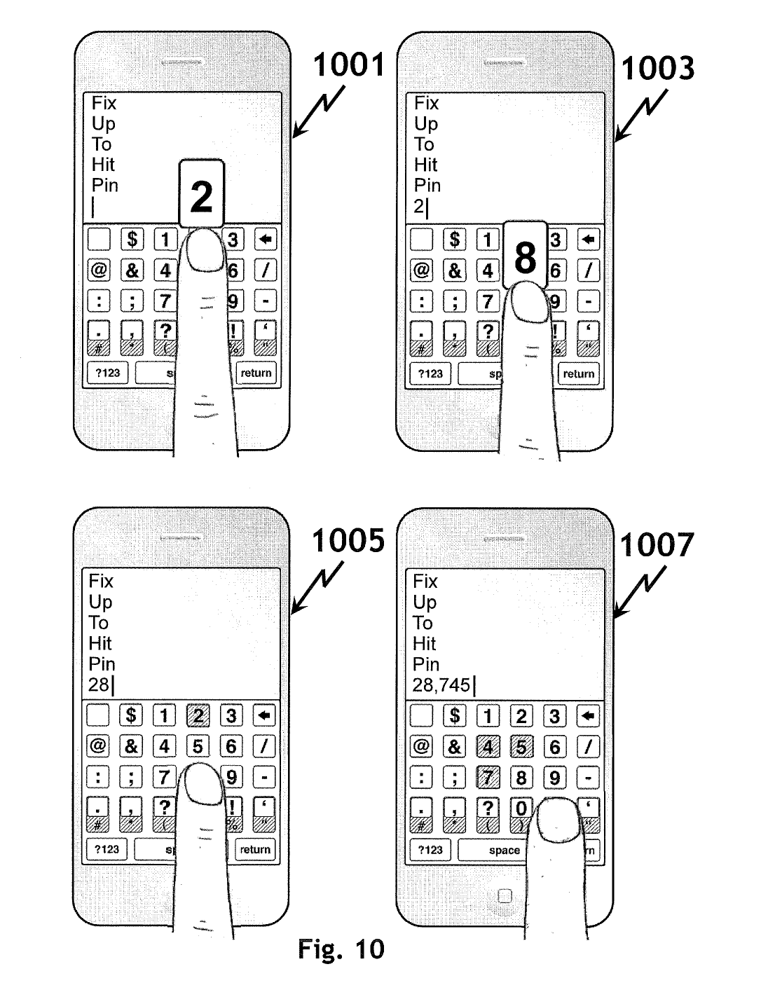

Referring to FIG. 10, the same methods shown in FIGS. 7, 8, and 9 are applied to the secondary display that is used for numbers and other characters.

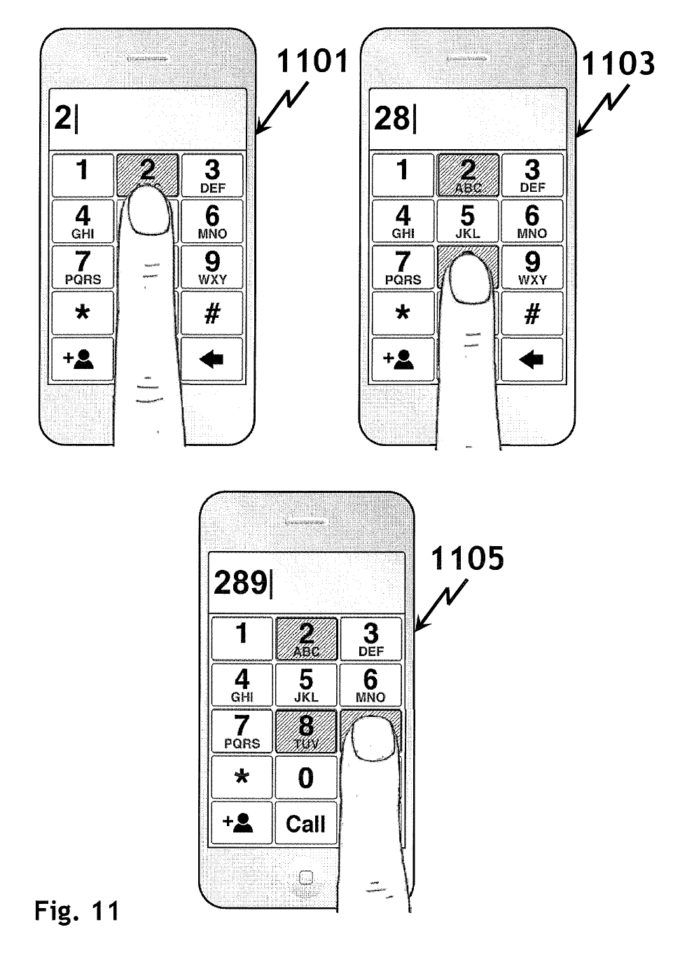

Referring to FIG. 11, a second embodiment—a numeric keypad for entering phone numbers—is shown. The same principles as described for the alphanumeric keypad are implemented as shown in screenshots 1101, 1103, 1105. In this embodiment, the user can subsequently place a telephone call by pressing the “Call” button.

A distinct novelty of the present invention is the deterministic actuation of multiple sequential buttons via pre-defined thresholds. Deterministic actuation solves a long-standing problem that has plagued prior-art implementations text entry via finger movements on touch-screen devices. Since the prior art was not deterministic, complex and inaccurate methods such as dictionary look-ups to “predict” button actuation was necessary. In addition, the present invention allows entry of partial words by sequential button actuation—which is not possible with the prior art.

As detailed in this application and its associated figures, the use of multi-function buttons and multiple, sequential button actuations are clear advances over the known art for alphanumeric character entry in touch-screen devices. In addition, the proposed invention can be cost effectively reduced to practice using appropriate adaptations of current software and hardware design techniques.

What is claimed is:

1. A method of entering alphanumeric characters into a hand-held processing system having a touch-screen display comprising:
(a) providing a multi-function display area of the touch screen display, said display area comprising at least two portions, a first portion visually displaying a first character and a second portion visually displaying a second character;
(b) entering said first character by (1) making touching contact with said multi-function display area and (2) releasing said touching contact; and
(c) entering said second character by (1) making touching contact with said multi-function display area, (2) sliding said touching contact in the direction of said second portion and (3) releasing said touching contact.

2. The method of claim 1 wherein said second portion subtends from said first portion.

3. The method of claim 1 wherein said first character is a more frequently used alphanumeric character than said second character.

4. The method of claim 1 wherein said second character is a punctuation mark.

5. The method of claim 1 wherein said first portion includes a first color and said second portion includes a second color, said first color being different than said subtending portion.

6. The method of claim 1 and further including generating a first sound associated with entering of said first character and generating a second different sound associated with entering of said second character.

7. The method of claim 1 and further including multiple multi-function display areas and multiple single-function display areas for use as an alphanumeric keypad.

8. The method of claim 6 wherein said single function buttons and said multi-function display areas are arranged on said touch-screen display rows and columns in a matrix array.

9. The method of claim 1 wherein the determination of the letters that are assigned to single function buttons and those that are assigned to multi-function buttons is based on statistics related to frequency of letter use and frequency of letter sequence.

10. A method of actuating control functions of a hand held processing system having a touch screen display, comprising
providing a multi-function button having a discrete display area comprising:
a first portion having first visual indicia; and
a second portion having second visual indicia;
actuating a first control function represented by said first visual indicia, said actuating including (1) touching any where on said multi-function display button; and (2) releasing said touching; and
actuating a second control function represented by said second visual indicia, said actuating including (1) touching any where on said multi-function display button, (2) touch sliding in the direction of said second portion, and (3) touch releasing.

11. The method of claim 10 wherein said first control function represents a more frequently used control function than said second control function.

12. The method of claim 10 wherein said primary portion includes a first color different than said primary subtending portion.

13. The method of claim 10 and further including generating a first sound associated with entering of said first character generating a second different sound associated with entering of said second character and subtending portions.

14. A method of entering two alphanumeric characters into a hand-held processing system having a touch-screen display comprising:
(a) providing a multi-function display area of the touch screen display, said display area comprising multiple portions, each of said portions representing a button;
(b) actuating first said button by (1) making touching contact with a portion representing said first button and (2) sliding said touching contact to a portion representing a said button from said first button; and
(c) actuating a second said button if the sliding said touching contact metts a selection criteria.

15. A method according to claim 14 wherein said selection criteria includes stopping the sliding said touching contact at a portion representing said second button.

16. A method according to claim 14 wherein one of said selection criteria includes changing the angle of the sliding said touching contact at a portion representing said second button.

17. A method according to claim 14 wherein said selection criteria includes either (1) stopping the sliding said touching contact at a portion representing said second button or (2) changing the angle of the sliding said touching contact at a portion representing said second button.

18. The method according to claim 14 wherein a said selection criteria includes the speed of the finger movement relative to the display dropping below a minimum threshold, at a portion representing said second button.

19. The method according to claim 14 wherein a said selection criteria includes a change in the angular direction of the sliding touching contact exceeding a maximum threshold, said change occurring at a portion representing said second button.

20. The method according to claim 14 and further including entering a third alphanumeric character, comprising actuating a third said button if the sliding said touching contact meets a said selection criteria.
